(19) United States
(12) Patent Application Publication
(10) Pub. No.: US 2010/0088946 A1
(43) Pub. Date: Apr. 15, 2010

(54) FISHING HOOK

(75) Inventor: Franz Josef Casutt, Peiden Dorf (CH)

Correspondence Address: SPECKMAN LAW GROUP PLLC, 1201 THIRD AVENUE, SUITE 330, SEATTLE, WA, 98101, US

(73) Assignee: EASY CATCH, Chur (CH)

(21) Appl. No.: 12/447,900

(22) PCT Filed: Dec. 21, 2006
(86) PCT No.: PCT/CH06/00727

§ 371 Date: Dec. 10, 2009

(30) Foreign Application Priority Data
Oct. 30, 2006 (CH) 1723/06

(51) Int. Cl. A01K 97/06; A01K 83/00

(52) U.S. Cl. 43/43.16; 43/57.1

(57) ABSTRACT

The invention relates to a fishing hook having three loose fishing rods (1), the shafts (2) of which are individually and detachably disposed in a profile piece (5) such that easier removal of a hook (3) from a fishing rod (1) from the mouth of a fish is enabled.

The invention relates to a fishing hook, in particular for fishing according to the preamble of the claim.

Fishing lures or fishing hooks are known for fishing freshwater fish. Thus DE-A-2026810 discloses a fishing lure made of a fish-shaped sheet of reflective material, the rotating blades in the lure consisting of flat material being formed in one piece with the lure sheet material.

In a spinner for fishing according to DE-C-10214536 a spoon lure made from a flat metal plate is provided, which rotates in the pulling direction in the water in the manner of a propeller. To this end, it is formed into two blades at its end facing the fishing hook.

A surface lure for fishing lines according to DE-U-29503885 comprises at the front end a bottom hook and at the rear end the fishing line. The bottom hook is releasably fastened to the surface lure via a predetermined rupture point, the predetermined rupture point being designed such that the force required to break the predetermined rupture point is less than the force required to break the fishing line fastened to the surface lure. As in the remaining prior art, the bottom hook consists of three hooks bent in a semi-circular manner, the bent end merging with a barb and the other end being formed straight in the shape of a shaft. The individual shafts are unreleaseably connected to a common shaft, which at the end merges with an eye or the like.

The object of the invention, therefore, is to provide a fishing hook which avoids the above drawbacks of the prior art, and which allows the removal of a fishing hook from the mouth of a fish with less pain or injury. The object is achieved by the features of the claim.

As the shafts of the hooks may be individually removed from the fishing tackle component and/or separately inserted therein, each hook may also be individually removed from the mouth of a fish and/or a fish does not have to bite into all hooks. Thus (for example) from the hitherto known one-piece treble hook, a system of separate fishing tackle components results. The new fishing hook “Casutt `Lix” saves the fish unnecessary pain and injury and simplifies the removal of the hooks from the mouth of a fish for anglers and fishermen.

Advantageous embodiments are disclosed in the sub-claims.

The fishing hook comprises at least two fishing tackle components with hooks, preferably however three fishing tackle components.

The invention is described in more detail in an embodiment with reference to a drawing, in which:

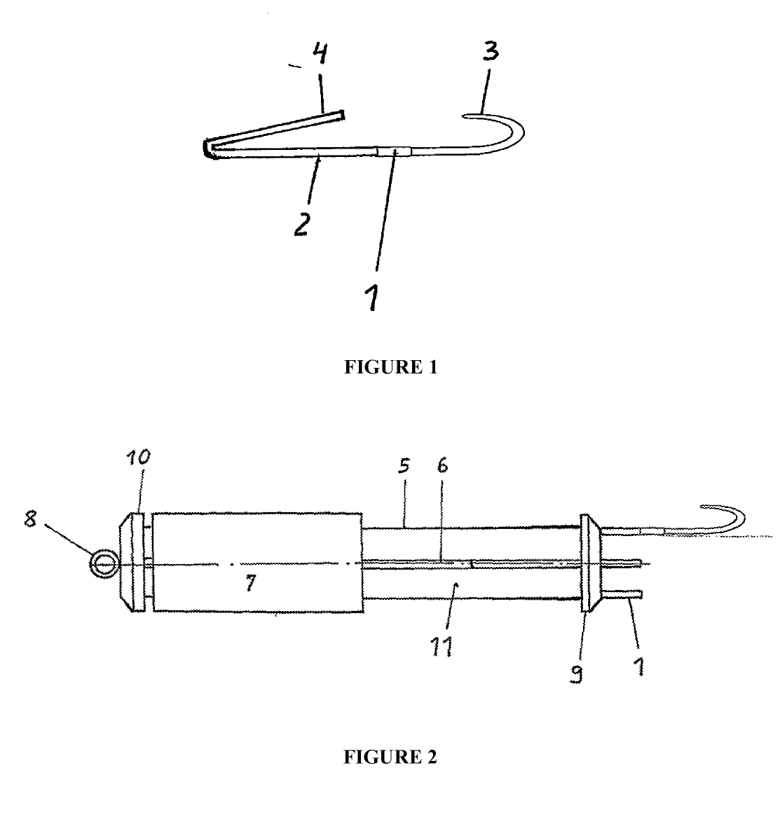

FIG. 1: shows a fishing tackle component

FIG. 2: shows a fishing hook.

A fishing hook comprises three individual fishing tackle components 1 with shafts 2 and hooks 3, the end 4 of the shaft remote from the hook 3 being bent to such an extent that only a small opening angle remains. The end 4 and the tip of the hook 3 are oriented towards one another.

The fishing tackle components 1 are releasably arranged in a profiled part 5. The profiled part 5 is defined on the front faces by a head 9 and/or an end piece 10, the diameter thereof being greater than that of the central part 11. On the central part 11 of the profiled part 5, a sleeve 7 is arranged which is displaceable between the head 9 and the end piece 10. The central part 11 comprises three continuous grooves 6 which terminate in slots in the head 9. Through the slots the individual fishing tackle components 1 are inserted into the grooves 6, with the end 4 oriented outwardly, by the elastic deformation thereof. During the insertion, the sleeve 7 bears against the end piece 10 of the profiled part 5. The ends 4 are inserted into the grooves 6 such that they preferably slightly protrude from the surface of the profiled part 5 in the direction of the head 9. When all fishing tackle components 1 are inserted, the sleeve 7 is pushed in the direction of the head 9 and the individual fishing tackle components 1 are fixed in the profiled part 5 and are ready for use. Only now does the fishing hook give the impression of a conventional treble hook.

If a fish has bitten into one or more hooks, each fishing tackle component 1 may be removed individually from the profiled part 5 by pushing back the sleeve 7, and a hook 3 may be removed from the mouth of a fish without further injury, etc. On the end piece 10 an eye 8 is arranged for attaching conventional fishing rod lines, spoon lures, etc.

The fishing tackle components 1 and profiled part 5, together with the sleeve 7, may consist of a wide variety of materials, but preferably of metal.

The invention is not limited to the embodiment shown.

### LIST OF REFERENCE NUMERALS

1 Fishing tackle component
2 Shaft
3 Hook
4 End
5 Profiled part
6 Groove
7 Sleeve
8 Eye
9 Head
10 End piece
11 Central part

1. A fishing hook comprising at least two fishing tackle components for fishing individual fish, the fishing tackle components being inserted individually and releasably into a profiled part of the fishing hook, wherein the profiled part comprises a central part with continuous groves in the longitudinal direction, and wherein a sleeve is longitudinally displaceably arranged on the central part, the length of displacement being defined by a head and an end piece of the profiled part.

2. The fishing hook according to claim 1, wherein the head comprises slots, which merge with grooves of the central part.

3. The fishing hook according to claim 2, wherein the shafts at one end are formed as conventional hooks and at the other end are bent sharply in the direction of the hook.

4. The fishing hook according to claim 1, wherein three fishing tackle components are arranged spaced apart in the profiled part at intervals of 120°.
